(19) United States
(12) Patent Application Publication
(10) Pub. No.: US 2025/0138781 A1
(43) Pub. Date: May 1, 2025

(54) PROCESSING UNIT COMPRISING AN ACTIVATION FUNCTION UNIT

(71) Applicant: Micron Technology, Inc., Boise, ID (US)

(72) Inventors: Xinyu Wu, Boise, ID (US); Peter L. Brown, Eagle, ID (US); Troy A. Manning, Meridian, ID (US)

(21) Appl. No.: 18/787,854

(22) Filed: Jul. 29, 2024

Related U.S. Application Data
(60) Provisional application No. 63/545,688, filed on Oct. 25, 2023.

(51) Int. Cl. G06F 7/523; G06F 7/50

(52) U.S. Cl. CPC G06F 7/523; G06F 7/50

(57) ABSTRACT

A processing unit can include an activation function unit. Data can be received at a plurality of registers of a processing unit of a memory sub-system. The data can be received at a multiply-accumulate (MAC) unit coupled to the plurality of registers. The first plurality of operations can be performed at the MAC unit to generate a first output. The first output can be provided to the activation function unit. The first output can be provided from the AFU to the plurality of registers utilizing a bus or a signal line that couples the plurality of registers to the AFU.

### PRIORITY INFORMATION

This application claims the benefit of U.S. Provisional Application No. 63/545,688, filed on Oct. 25, 2023, the contents of which are incorporated herein by reference.

### TECHNICAL FIELD

Embodiments of the disclosure relate generally to a processing unit, and more specifically, relate to a processing unit comprising an activation function unit.

### BACKGROUND

Various types of electronic devices such as digital logic circuits and memory systems may store and process data. A digital logic circuit is an electronic circuit that processes digital signals or binary information, which can take on two possible values (usually represented as 0 and 1). The digital logic circuit can use logic gates to manipulate and transform the digital signals or binary information. Digital logic circuits can be, for example, used in a wide range of electronic devices including computers, calculators, digital clocks, and many other electronic devices that employ digital processing. Digital logic circuits can be designed to perform specific logical operations on digital inputs to generate digital outputs, and, in some instances, can be combined to form more complex circuits to perform more complex operations. A memory device can include one or more memory devices that store data. The memory devices can be, for example, non-volatile memory devices and volatile memory devices. In general, a host system can utilize a memory system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a block diagram of a memory device and processing units in accordance with some embodiments of the present disclosure.

FIG. 3 is a block diagram of a processing unit in accordance with some embodiments of the present disclosure.

FIG. 4 is a block diagram of a processing unit implemented using buses in accordance with some embodiments of the present disclosure.

FIG. 5 illustrates a table showing pseudocode for implementing a polynomial function in accordance with a number of embodiments of the present disclosure.

FIG. 6 illustrates a table showing pseudocode for implementing a hard-gaussian error linear activation unit approximation in accordance with a number of embodiments of the present disclosure.

FIG. 7 illustrates a table showing pseudocode for implementing an integer-gaussian error linear activation unit approximation in accordance with a number of embodiments of the present disclosure.

FIG. 8 is a flow diagram corresponding to a method for implementing a processing unit comprising an activation function unit in accordance with some embodiments of the present disclosure.

FIG. 9 is a block diagram of an example computer system in which embodiments of the present disclosure may operate.

### DETAILED DESCRIPTION

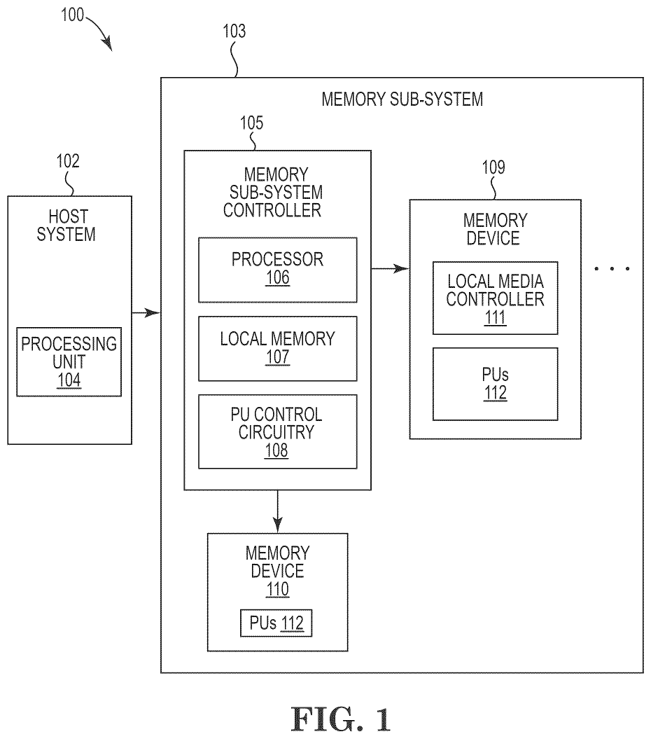

Aspects of the present disclosure are directed to a processing unit comprising an activation function unit (AFU). A processing unit can comprise a plurality of registers, a multiply-accumulate (MAC) unit, and an activation function unit. The plurality of registers can store data provided by an array. The MAC unit can perform a first plurality of operations on the data. The AFU can perform a second plurality of operations on an output of the MAC unit. The processing unit can also include a plurality of signal lines that couple the AFU to the plurality of registers and which is configured to provide an output of the AFU unit to the plurality of registers to perform a polynomial operation. The polynomial operation can be used as an activation function and/or can be used to approximate an activation function of an artificial neural network (ANN). The ANN can be implemented in a memory sub-system. A memory sub-system can be a storage system, storage device, a memory module, or a combination of such. An example of a memory sub-system is a storage system such as a dynamic random-access memory (DRAM). Examples of storage devices and memory modules are described below in conjunction with FIG. 1, et alibi. In general, a host system can utilize a memory sub-system that includes one or more components, such as memory devices that store data. The host system can provide data to be stored at the memory sub-system and can request data to be retrieved from the memory sub-system.

Although some non-limiting examples herein are generally described in terms of applicability to memory sub-systems and/or to memory devices, embodiments are not so limited, and aspects of the present disclosure can be applied as well to a system-on-a-chip, computing sub-system, data collection and processing, storage, networking, communication, power, artificial intelligence, control, telemetry, sensing and monitoring, digital entertainment and other types of systems/sub-systems and/or devices. Accordingly, aspects of the present disclosure can be applied to these components in order to calculate and/or implement an activation function for an ANN, as described herein.

As used herein, the ANN can provide learning by forming probability weight associations between an input and an output. The probability weight associations can be provided by a plurality of nodes that comprise the ANN. The nodes together with weights, biases, and activation functions can be used to generate an output of the ANN based on the input to the ANN. A plurality of nodes of the ANN can be grouped to form layers of the ANN. Signals provided from one layer of a plurality of nodes to another layer of the plurality of notes can cause the ANN to process an input to generate an output. The signals are provided from one layer of the plurality of nodes to another layer based on an activation of each of the plurality of nodes of the layer. An activation can occur when a particular node receives a plurality of signals (e.g., spikes) sufficient to reach a threshold. When the particular node reaches a threshold, the particular node will provide its signal to one or more nodes of a subsequent layer of the ANN.

The threshold and/or the combination of weights, biases, and signals provided by other nodes of an ANN can be defined by an activation function. The activation function can be utilized to determine when to forward propagate signals received by a particular node of the ANN. The activation function can be utilized by an ANN to use relevant signals and suppress irrelevant signals.

There are many types of activation functions which can be utilized for specific problems being solved by the ANN. For example, activation functions can include a binary step activation function, a Sigmoid Linear Unit (SiLU) activation function, a Hyperbolic Tangent (TanH) activation function, a Rectified Linear Unit (ReLU) activation function, a Leaky ReLU activation function, an Exponential Linear Unit (ELU) activation function, a Softmax activation function, and a Gaussian Error Linear Unit (GELU) activation unit, among other activation functions.

Processing units (PUs) that are used to implement an ANN can be configured to implement an activation function. However, implementing one or a limited quantity of activation functions limits the applicability of a PU to particular problems that may be better solved utilizing different activation functions not supported by the PU.

In order to address these and other deficiencies of current approaches, embodiments of the present disclosure allow for a PU to be implemented utilizing an activation function unit. The PUs can also be referred to as process-in-memory (PIM) units. The PUs can perform a number of operations in a memory sub-system (e.g., memory device) including operations for implementing or training an ANN which utilizes activation function(s). The activation function unit (AFU) can be utilized to implement a greater number of activation functions by performing atomic operations and by utilizing a multiply-accumulate (MAC) unit. The AFU and the MAC unit can be utilized to approximate a greater number of activation functions than a PU that is configured to implement a limited quantity of activation functions. The output of the ANN may be correct a greater percentage of the time utilizing a PU that approximates a greater number of activation functions than a PU that implements a single activation function or a limited number of activation functions.

FIG. 1 illustrates an example computing system 100 that includes a memory sub-system 103 in accordance with some embodiments of the present disclosure. The memory sub-system 103 can include media, such as one or more volatile memory devices (e.g., memory device 110), one or more non-volatile memory devices (e.g., memory device 109), or a combination of such.

A memory sub-system 103 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

In other embodiments, the computing system 100 can be deployed on, or otherwise included in a computing device such as a desktop computer, laptop computer, server, network server, mobile computing device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. As used herein, the term “mobile computing device” generally refers to a handheld computing device that has a slate or phablet form factor. For example, a mobile computing device can include a mobile phone, a tablet, an entertainment device, a gaming device, a navigation device, a photo/video camera etc. In general, a slate form factor can include a display screen that is between approximately 3 inches and 5.2 inches (measured diagonally), while a phablet form factor can include a display screen that is between approximately 5.2 inches and 7 inches (measured diagonally). Examples of “mobile computing devices” are not so limited, however, and in some embodiments, a “mobile computing device” can refer to an IoT device, among other types of edge computing devices.

The computing system 100 can include a host system 102 that is coupled to one or more memory sub-systems 103. In some embodiments, the host system 102 is coupled to different types of memory sub-system 103. FIG. 1 illustrates one example of a host system 102 coupled to one memory sub-system 103. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 102 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 102 uses the memory sub-system 103, for example, to write data to the memory sub-system 103 and read data from the memory sub-system 103.

The host system 102 includes a processing unit 104. The processing unit 104 can be a central processing unit (CPU) that is configured to execute an operating system. In some embodiments, the processing unit 104 comprises a complex instruction set computer architecture, such an x86 or other architecture suitable for use as a CPU for a host system 102.

The host system 102 can be coupled to the memory sub-system 103 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 102 and the memory sub-system 103. The host system 102 can further utilize an NVM Express (NVMe) interface to access components (e.g., memory devices 109) when the memory sub-system 103 is coupled with the host system 102 by the PCIe interface. The physical host interface can provide an interface for passing control, address, data, and other signals between the memory sub-system 103 and the host system 102. FIG. 1 illustrates a memory sub-system 103 as an example. In general, the host system 102 can access multiple memory sub-systems via the same communication connection, multiple separate communication connections, and/or a combination of communication connections.

The memory devices 109, 110 can include any combination of the different types of non-volatile memory devices and/or volatile memory devices. The volatile memory devices (e.g., memory device 110) can be, but are not limited to, random access memory (RAM), such as dynamic random-access memory (DRAM) and synchronous dynamic random access memory (SDRAM).

Some examples of non-volatile memory devices (e.g., memory device 109) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 109, 110 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLC) can store multiple bits per cell. In some embodiments, each of the memory devices 109 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 109 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 109 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

The memory sub-system controller 105 (or controller 105 for simplicity) can communicate with the memory devices 109 to perform operations such as reading data, writing data, or erasing data at the memory devices 109 and other such operations. The memory sub-system controller 105 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 105 can be a microcontroller, special purpose logic circuitry (e.g., a field programmable gate array (FPGA), an application specific integrated circuit (ASIC), etc.), or other suitable processor.

The memory sub-system controller 105 can include a processor 106 (e.g., a processing device) configured to execute instructions stored in a local memory 107. In the illustrated example, the local memory 107 of the memory sub-system controller 105 includes an embedded memory configured to store instructions for performing various processes, operations, logic flows, and routines that control operation of the memory sub-system 103, including handling communications between the memory sub-system 103 and the host system 102.

In some embodiments, the local memory 107 can include memory registers storing memory pointers, fetched data, etc. The local memory 107 can also include read-only memory (ROM) for storing micro-code. While the example memory sub-system 103 in FIG. 1 has been illustrated as including the memory sub-system controller 105, in another embodiment of the present disclosure, a memory sub-system 103 does not include a memory sub-system controller 105, and can instead rely upon external control (e.g., provided by an external host, or by a processor or controller separate from the memory sub-system).

In general, the memory sub-system controller 105 can receive commands or operations from the host system 102 and can convert the commands or operations into instructions or appropriate commands to achieve the desired access to the memory device 109 and/or the memory device 110. The memory sub-system controller 105 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 109. The memory sub-system controller 105 can further include host interface circuitry to communicate with the host system 102 via the physical host interface. The host interface circuitry can convert the commands received from the host system into command instructions to access the memory device 109 and/or the memory device 110 as well as convert responses associated with the memory device 109 and/or the memory device 110 into information for the host system 102.

The memory sub-system 103 can also include additional circuitry or components that are not illustrated. In some embodiments, the memory sub-system 103 can include a cache or buffer (e.g., DRAM) and address circuitry (e.g., a row decoder and a column decoder) that can receive an address from the memory sub-system controller 105 and decode the address to access the memory device 109 and/or the memory device 110.

In some embodiments, the memory device 109 includes local media controllers 111 that operate in conjunction with memory sub-system controller 105 to execute operations on one or more memory cells of the memory devices 109. An external controller (e.g., memory sub-system controller 105) can externally manage the memory device 109 (e.g., perform media management operations on the memory device 109). In some embodiments, a memory device 109 is a managed memory device, which is a raw memory device combined with a local controller (e.g., local controller 111) for media management within the same memory device package. An example of a managed memory device is a managed NAND (MNAND) device.

The memory sub-system 103 can include PU control circuitry 108. Although not shown in FIG. 1 so as to not obfuscate the drawings, the PU control circuitry 108 can include various circuitry to facilitate aspects of the disclosure. In some embodiments, the PU control circuitry 108 can include special purpose circuitry in the form of an ASIC, FPGA, state machine, hardware processing device, and/or other logic circuitry that can allow the PU control circuitry 108 to orchestrate and/or control a PU 112 to perform a plurality of operations to approximate a plurality of activation functions, particularly with respect to a system-on-chip, in accordance with the disclosure.

In some embodiments, the memory sub-system controller 105 includes at least a portion of the PU control circuitry 108. For example, the memory sub-system controller 105 can include a processor 106 (processing device) configured to execute instructions stored in local memory 107 for performing the operations described herein. In some embodiments, the PU control circuitry 108 is part of the host system 103, an application, or an operating system. The PU control circuitry 108 can be resident on the memory sub-system 103 and/or the memory sub-system controller 105. As used herein, the term “resident on” refers to something that is physically located on a particular component. For example, the PU control circuitry 108 being “resident on” the memory sub-system 103 refers to a condition in which the hardware circuitry that comprises the PU control circuitry 108 is physically located on the memory sub-system 103. The term “resident on” may be used interchangeably with other terms such as “deployed on” or “located on,” herein.

The PU control circuitry 108 can provide commands to the PUs 112 implemented in the memory devices 109, 110. Implementing the PUs 112 in the memory devices 109, 110 has the advantage of limiting the movement of data between arrays of the memory devices 109,110 and the PUs 112. Limiting the movement of data between the arrays of the memory devices 109, 110 and the PUs 112 can increase the efficiency of operating an ANN (not shown). In various instances, the ANN can be implemented in the memory sub-system 103 and/or the memory devices 109, 110. The PUs 112 can implement an activation function and can provide the results of the activation function to the ANN for execution of the ANN. In various instances, the activation function can be utilized for purposes other than the execution of the ANN.

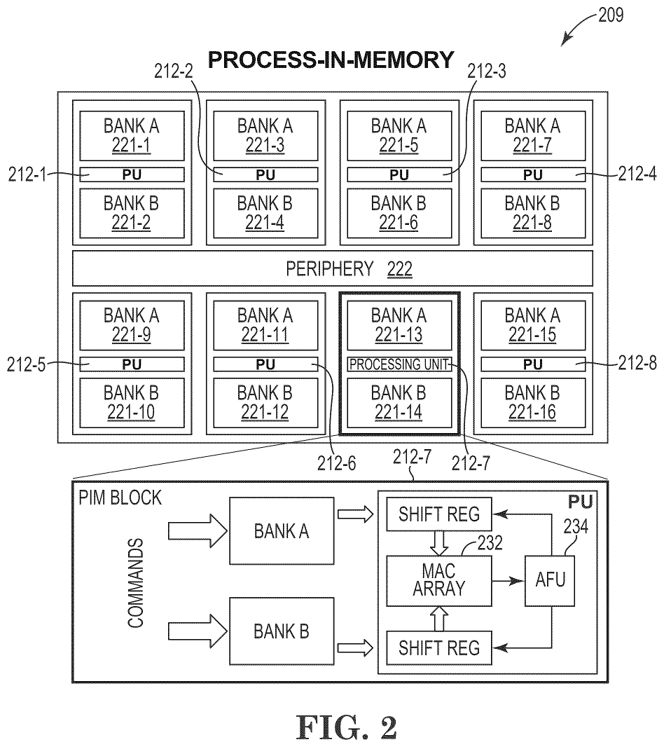

FIG. 2 is a block diagram of a memory device 209 and processing units in accordance with some embodiments of the present disclosure. The memory device 209 is labeled as corresponding to memory device 109 of FIG. 1. However, the memory device 209 can be implemented as a volatile memory device or a non-volatile memory device and can also correspond to the memory device 110 of FIG. 1. The memory device 209 includes banks 221-1, 221-2, 221-3, 221-4, 221-5, 221-6, 221-7, 221-8, 221-9, 221-10, 221-11, 221-12, 221-13, 221-14, 221-15, 221-16, referred to as banks 221. The memory device 209 also includes PUs 212-1, 212-2, 212-3, 212-4, 212-5, 212-6, 212-7, 212-8 referred to as PUs 212.

The banks 221 can be arranged in groups (e.g., bank groups). For example, the bank 221-1 and the bank 221-2 can be a first group. The bank 221-3 and the bank 221-4 can be a second group. The bank 221-5 and the bank 221-6 can be a third group. The bank 221-7 and the bank 221-8 can be a fourth group. The bank 221-9 and the bank 221-10 can be a fifth group. The bank 221-11 and the bank 221-12 can be a sixth group. The bank 221-13 and the bank 221-14 can be a seventh group. The bank 221-15 and the bank 221-16 can be an eighth group.

The PUs 212 can be part of a bank group or can be implemented to receive data from banks in a bank group. For instance, PU 212-1 can be part of the first group. PU 212-2 can be part of the second group. PU 212-3 can be part of the third group. PU 212-4 can be part of the fourth group. PU 212-5 can be part of the fifth group. PU 212-6 can be part of the sixth group. PU 212-7 can be part of the seventh group. PU 212-8 can be part of the eighth group.

The PU 212-1 can receive data from the banks 221-1, 221-2. The PU 212-2 can receive data from the banks 221-3, 221-4. The PU 212-3 can receive data from the banks 221-5, 221-6. The PU 212-4 can receive data from the banks 221-7, 221-8. The PU 212-5 can receive data from the banks 221-9, 221-10. The PU 212-6 can receive data from the banks 221-11, 221-12. The PU 212-7 can receive data from the banks 221-13, 221-14. The PU 212-8 can receive data from the banks 221-15, 221-16. The PUs 212 can be implemented between the banks 221 and a global bus 222. The implementation of a PU per bank group is exemplary. Other examples of PUs and bank groups can be implemented. For instance, a PU can be implemented per bank or a PU per multiple bank groups can be implemented, among other implementations of PUs 212 and banks 221.

The MAC array 232 can include a plurality of registers and several arithmetic and logic processing units. For example, each of the PUs 212 can include a MAC array 232. The MAC array 232 can also be referred to as a MAC unit. The MAC array 222 can include hardware to compute the product of two numbers and accumulate the result using an accumulator. A register of the MAC array 232 that stores the accumulated results can also be referred to as an accumulator. The PUs 212 can also include an AFU 224.

The PUs 212 can be controller using the PU control circuitry 108 of FIG. 1. The PU control circuitry 108, in various examples, can be part of a command decoder. Process-in-memory (PIM) commands can be provided to the memory device 209 on standard DDR command buses from the PU control circuitry 108, for example. An extended command decoder can decode command and can send control signals to the PU 212 in addition to sending the DDR commands such as read, write mode register read and write commands, etc.

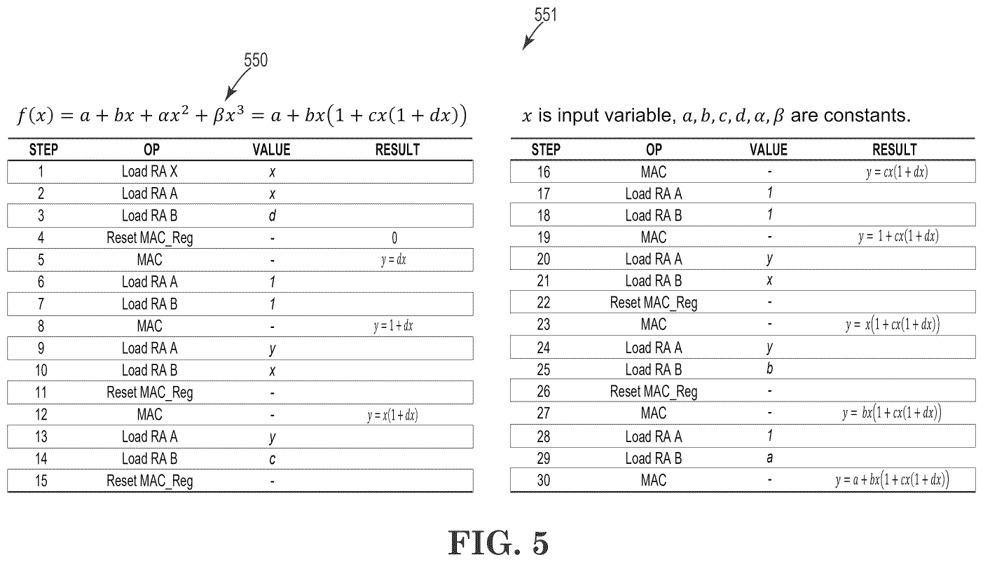

The AFU 234 can comprise hardware and/or firmware for performing a plurality of operation. The operations performed by the AFU 234 can include atomic operations. As described herein, atomic operations include any basic arithmetic operation such as addition operations, subtraction operations, and multiplication operations. The atomic operations can include operations not performed by the MAC array 232. Additional examples of operations performed by the AFU 234 are provided in FIGS. 5, 6, and 7.

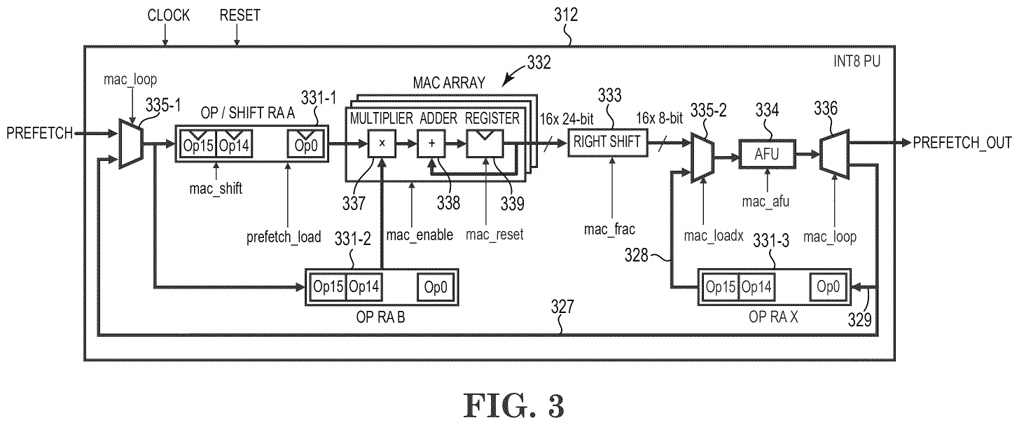

FIG. 3 is a block diagram of a PU 312 in accordance with some embodiments of the present disclosure. The PU 312 includes registers 331-1 (OP/SHIFT RA A) and 331-2 (OP RA B), MAC array 332, shift registers 333, and an AFU 334. The PU 312 also includes multiplexors (MUXs) 335-1, 335-2, de-MUX 336, registers 331-3 (OP RA X), and signal lines 327, 328, 329. Signal lines may be referred to as “lines” herein.

In various instances, the PU 312 can receive data from a plurality of banks of a memory device. The data can be stored in the registers 331-1, 331-2. For example, data provided by a first register can be stored in registers 331-1 and data provided by a second register can be stored in the registers 331-2. The registers 331-1, 331-2 can provide data to the MAC array 332. The data provided by the registers 331-1, 331-2 can be referred to as operators (e.g., operator A, operator B). The registers 331-1 can be coupled to a clock signal as denoted by the inverted triangles shown in the registers 331-1. The clock signals can be utilized to enable the registers 331-1 to shift right or left the data stored therein.

The MAC array 332 can include a multiplier 337, an adder 338, and a register 339. The multiplier 337 can perform multiplication operations utilizing the data store in the registers 331-1 and 331-2. The adder 338 can perform addition operation to accumulate the results of the multiplier 337. The adder 338 can store the results in the register 339. The register 339 can be reset (e.g., mac_reset). The register 339 can be reset utilizing a clock signal denoted by the inverted triangle. In previous approaches, a reset signal is utilized to reset the PU unit including the registers 331-1, 331-2. In a number of examples, the reset signal is used to reset the register 339 and not the registers 331-1, 331-2, 331-3.

The multiplier 337 can be an integer multiplier. The multiplier 337 can multiply two fixed-point values (e.g., operator A and operator B) provided by the registers 331-1, 331-2. The adder 338 can be an integer adder. The adder 338 can add multiplied results with the value stored in the register 339. The register 339 can also be referred to as an accumulation register or an accumulator. The register 339 can store accumulated results. The register 333 can scale MAC results down.

The data stored in the registers 331-1, 331-2, can be referred to as prefetch data. The registers 331-1, 331-2 and the MAC array size can match the prefetch data width and the integer data width. For instance, a prefetch width (e.g., width of the prefetch data) can be 128-bits and the MAC array 332 can provide 8-bits of data which means that 16 MAC arrays can be implemented in the PU 312 (e.g., 128/8=16). There can be 16 instances of the MAC array 332 in the PU 312.

The AFU 334, the MUXs 335-1, 335-2, the de-MUX 336, the registers 331-3, and the lines 327, 328, 329 enable the PU 312 to perform a plurality of non-linear activation functions. Various activation functions are complex and utilize resources of memory device that may be better served elsewhere. The PU 312 can approximate and/or perform various non-linear activation functions such as GELU, SiLU, ELU, and ReLU with polynomial approximation, among other activation functions.

The AFU 334 can perform atomic functions which can supplement the operations that are supported by the MAC array 332. For example, the AFU 334 can perform operations that the MAC array 332 does not perform. The lines 327 enable the output of the AFU 334 to be provided as an input to the MAC array 332 via the registers 331-1, 331-2. Providing the output of the AFU 334 as an input to the MAC array 332 enables the PU 312 to perform polynomial operations. As used herein, a polynomial operation includes a plurality of operations that when combined reflect a polynomial equation. The lines 328, 329 also enable the output of the AFU 334 to be provided as an input to the AFU 334 via the registers 331-3. For example, the register 331-3 can store an output of the AFU 334 and can provide the output of the AFU 334 as an input to the AFU 334 utilizing the lines 328, 329. Although a single line is shown for the lines 327, 328, 329, each of the lines 328, 328, 329 can include multiple signal lines.

The MUXs 335-1, 335-2 and the de-MUX 336 enable the output of the AFU 334 to be provided as an input to the MAC array 332 or the AFU 334. For instance, the de-MUX 336 can receive the output of the AFU 334 and can cause, based on a configuration of the de-MUX 336, the output of the AFU 334 to be provided to a global bus of the memory device or to the registers 331-3 and the MUX 335-1 utilizing the lines 327, 329.

The MUX 335-1 can receive data from the banks or from the de-MUX 336. The MUX 335-1 can be configured to provide data received from the de-MUX 336 via the lines 327 to the registers 331-1, 331-2. Providing the output of the AFU 334 to the registers 331-1, 331-2 enables the registers 331-1, 331-2 to store the output of the AFU 334 as operators A and B.

The register 331-1 can perform shift operations on the output of the AFU 334. The registers 331-1 can provide the output of the AFTU 334 to the MAC array 332 or the shifter output of the AFU 334 to the MAC array 332. The MAC array 332 can receive the output of the AFU 334 as operators A and B. The MAC array 332 can perform a plurality of operations utilizing the output of the AFU 334 as an input. The output of the MAC array 332 can be provided to the registers 333 and from the registers 333 to the MUX 335-2.

The de-MUX 336 can also cause an output of the AFU 334 to be provided to the registers 331-3 utilizing the lines 329. The registers 331-1 can provide the output of the AFU 334 to the MUX 335-2 via the line 328. The MUX 335-2 can be configured to provide the output of the register 333 or the data stored in the registers 331-3 as an input to the AFU 334. The MUX 335-2, the de-MUX 336, the line 329, and the registers 331-3 can allow the AFU 334 to perform atomic operations on the output of different atomic operations. In various instances, the atomic operations can include operations that are used to estimate the non-linear activation functions or portion of the non-linear activation functions. For example, the AFU 334 can perform a −sign( ) operation or a ReLU6 operation. The AFU 334 can include logic blocks implementing functions of clipping the input value or a given maximum or minimum value. The AFU 334 can also include logic blocks implementing functions of returning the sign of the input value.

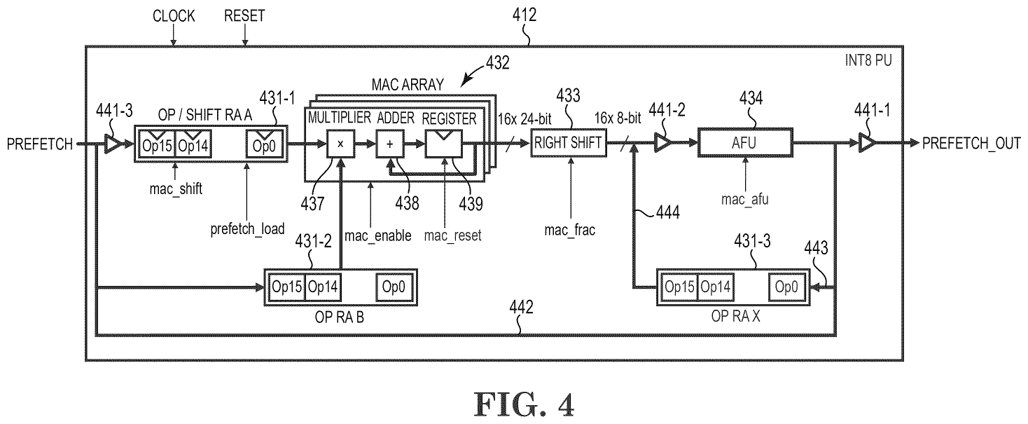

In various instances, the AFU 334 and the MUXs 335-1, 335-2, the de-MUX 336, the lines 327, 328, 329, and the registers 331-3 can enable the PU 312 to combine a number of operations to build non-linear activation functions or to approximate non-linear activation functions. The non-linear activation functions constructed utilizing the PU 312 can be provided to an ANN via a global bus for example or can be stored back to the banks of the memory device. FIG. 4 describes the implementation of the PU 312 utilizing buses instead of lines. FIGS. 5, 6, 7 provide examples of pseudocode for utilizing the PU 312 to implement non-linear activation functions.

FIG. 4 is a block diagram of a PU 412 implemented using buses in accordance with some embodiments of the present disclosure. The PU 412 includes registers 431-1 and 431-2, MAC array 432, shift registers 433, and an AFU 434. The PU 312 also includes tri-state buffers 441-1, 441-2, 441-3 and buses 442, 443, 444.

The PU 412 can provide the output of the AFU 434 to itself as an input and/or the output of the AFU 434 to the registers 431-1, 431-2 as inputs utilizing the buses 442, 443, 444. The PU 412 can provide the output of the AFU 434 to the MAC array 432 and/or to the AFU 434 utilizing the buses 442, 443, 444 instead of utilizing the lines 327, 328, 329 of FIG. 3. The difference between the lines 327, 329, 328 (e.g., signal lines) of FIG. 3 and the buses 442, 443, 444 is that the buses include multiple signal lines and the lines include a single signal line. The differences between the lines and the buses 442, 443, 444, may lead to the utilization of the buses 442, 443, 444 in various scenarios over the lines.

In various instances, the tri-state buffers 441-1, 441-2, 441-3 can allow data to be provided to the buses 442, 443, 444. For example, tri-state buffer 441-1 can be activated or deactivated to allow the AFU 434 to provide data to the buses 442, 443 or the global bus (not shown). The tri-state buffer 441-2 can be activated to allow the registers 431-3 to provide data to the AFU 434 via the bus 444. The tri-state buffer 441-3 can also be activated to allow the bus 442 to provide data to the registers 431-1 and 431-2.

FIG. 5 illustrates a table 551 showing pseudocode for implementing a polynomial function 550 in accordance with a number of embodiments of the present disclosure. The table 551 shows pseudocode for a step, a value associated with the step, and a result of performing the step.

The polynomial function 550 is defined as f(x)=a+bs+ax2+βx3=a+bx(1+cx(1+dx)) where x is an input and a, b, c, d, a and β are constants. At step 1, the registers X (RA X) can be loaded with an x value. RA X can be loaded by, for example, reading the value x from the memory array and providing the value x to the MAC array. The MAC array can multiply x by 1 to output the value x. The right shift register (e.g., register 333 in FIG. 3) can refrain from shifting the value x. The value x can be provided to the AFU. The AFU can be provided a command to pass the value x without performing steps utilizing the value x. The output of the AFU (e.g., x) can be stored in the RA X.

At step 2, the register A (RA A) can be loaded with the x value. The value x can be read from the memory array or the value x can be provided from as the output of the AFU. At step 3, the register B (RA B) can be loaded with the d value. The value d can be read from the memory array and stored in the RA B. The accumulator of the MAC array can be reset to a 0 value in step 4. At step 5, the MAC array can be utilized to perform a multiplication operation to multiply the values x and d resulting in the expression y=dx, which can be part of the polynomial function 550 (e.g., a+bx(1+cx(1+dx))).

At step 6, RA A can store a 1 value. At step 7, RA B can store a 1 value. At step 8, the MAC array can be utilized to add a 1 value to the dx value resulting in the expression y=1+dx which is part of the polynomial function 550 (e.g., a+bx(1+cx(1+dx))). The accumulator of the MAC array was not reset between steps 5 and 8. The accumulator retained the value dx which allowed it to perform an addition operation utilizing the adder and accumulate the 1 value to the dx value. As used herein, the register 339 of the MAC array 332 of FIG. 3 can be referred to as an accumulator.

At step 9, RA A is loaded with the y value which is the 1+dx value. At step 10, RA B is loaded with the x value. At step 11, the MAC array is reset (e.g., an accumulator of the MAC array is reset). At step 12, the MAC array performs a multiplication operation utilizing the multiplier such that the output of the accumulator y=x(1+dx).

At step 13, RA A is loaded with the y value. RA A can be loaded with the value y by outputting y from the MAC array. The value y can be provided to the AFU. The AFU can pass the y value without performing additional operations. The y value can be stored in RA A. At step 14, RA B is loaded with the c value. At step 15, the accumulator of the MAC array is reset. At step 16, the MAC array can be utilized to perform a multiplication operation to multiply the c value and the y value (e.g., x(1+dx)). The accumulator of the MAC array can store the value y=cx(1+dx) which is part of the polynomial function 550 (e.g., a+bx(1+cx(1+dx))).

At step 17, RA A can be loaded with the 1 value. At step 18, RA B can be loaded with the 1 value. At step 19, the MAC array can add the 1 value to the values stored in the accumulator to produce the value y=1+cx(1+dx).

At step 20, RA A is loaded with the y value. At step 21, RA B is loaded with the x value. At step 22, the accumulator of the MAC array is reset. At step 23, the MAC array performs a multiplication operation utilizing the x value and the y value which results in y=x(1+cx(1+dx)).

At step 24, RA A is loaded with the y value. At step 25, RA B is loaded with the b value. At step 26, the accumulator of the MAC array is reset. At step 27, the MAC array performs a multiplication operation utilizing the b value and the y value which results in y=bx(1+cx(1+dx)).

At step 28, RA A is loaded with the 1 value. At step 29, RA B is loaded with the a value. At step 30, the MAC array performs an addition operation to add the value a to y=bx(1+cx(1+dx)) which is stored in the accumulator and which results in y=a+bx(1+cx(1+dx)). The MAC array can perform a multiplication operation prior to adding a to y=bx(1+cx(1+dx)). For example, the MAC array can multiply the a value and the/value resulting in the value a which can then be added to the value stored in the accumulator (e.g., register). The MAC array can then output y=a+bx(1+cx(1+dx)) to the AFU. The AFU can output y=a+bx(1+cx(1+dx)) to the global bus. The activation function y=a+bx(1+cx(1+dx)) can be utilized to execute an ANN. The output y=a+bx(1+cx(1+dx)) is equal to the activation function 550 (e.g., f(x)=a+bx(1+cx(1+dx))).

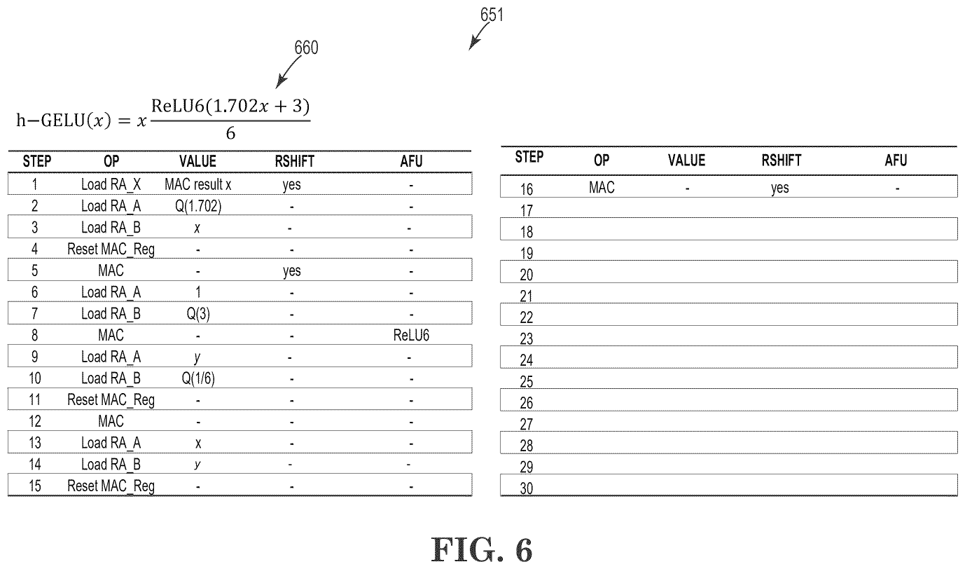

FIG. 6 illustrates a table 661 showing pseudocode for implementing a hard-GELU (h-GELU) approximation 660 in accordance with a number of embodiments of the present disclosure. The table 661 shows pseudocode for a step, a value associated with performing the step, whether the right shift registers right shift data, and an atomic operation performed by the AFU.

$$h - GELU ( x ) = x \frac{ReLU 6 ( 1.702 x + 3 )}{6}$$

The h-GELU approximation 660 is expressed as where x is an input and ReLU6 is an atomic operation performed by the AFU. At step 1, the RA X is loaded with the x value (e.g., MAC result x). The value x can also be right shifted before being stored in RA X. The right shifting allows the output of the MAC to be in a same format as is used to store data in the registers or is used to perform operation using the AFU. For example, the data provided by the MAC can include 24 bits. The right shift can be used to provide 8 bit data to the AFU. The MAC array can output the value x to the AFU. The AFU can output the x value to the RA X. At step 2, RA A can store the value 1.702. At step 3, RA B can store the value x. The value x can be provided to the RA B from the RA X. For example, the value x can be read from the RA X and provided to the AFU. The AFU can refrain from performing operations using the value x and can provide the value x to the MUX 335-1 of FIG. 3. The MUX can provide the value x to the RA B. At step 4, the accumulator of the MAC array can be reset. At step 5, the MAC array can perform a multiplication operation utilizing the x value and the 1.702 value such that y=1.702x.

At step 6, RA A can store the value 1. At step 7, RA B can store the value 3. At step 8, the MAC array can multiply the values 1 and 3 such that the output is the value 3. The value 3 can be added to the value stored in the accumulator which is the value 1.702x. The output of the MAC array can be y=1.702x+3. The output of the MAC array can be provided to the AFU. The AFU can perform the ReLU6 operation utilizing the 1.702x+3 as an input such that the output of the AFU is y=ReLU6 (1.702x+3).

At step 9, RA A can store the value y (e.g., ReLU6 (1.702x+3)). At step 10, RA B can store the value ⅙. At step 11, the accumulator of the MAC array can be reset. At step 12, the MAC array can multiply ReLU6 (1.702x+3) by ⅙ to generate the output

$$y = \frac{ReLU ( 1.702 x + 3}{6} .$$

At step 13, RA A can store the value x. At step 14, RA B can store the value y

$$( e . g . , \frac{ReLU ( 1.702 x + 3}{6} ) .$$

At step 15, the accumulator of the MAC array can be reset. At step 16, the MAC array can multiply the values x and

$$\frac{ReLU ( 1.702 x + 3}{6}$$

to generate the output

$$y = x \frac{ReLU ( 1.702 x + 3}{6}$$

which can be used as an activation function that approximates h-GELU 660. FIG. 6 provides an example of the utilization of the AFU for performing atomic operations. The AFU can be utilized to approximate an activation function without requiring the particular hardware utilized for performing the activation function (e.g., h-GELU).

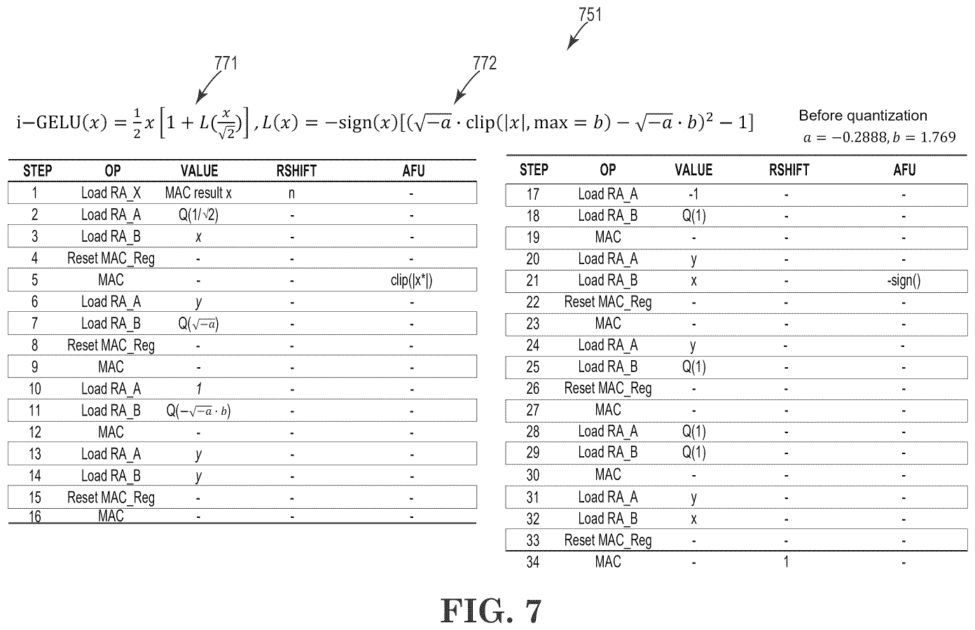

FIG. 7 illustrates a table 751 showing pseudocode for implementing an integer-GELU (i-GELU) approximation 771 in accordance with a number of embodiments of the present disclosure. The table 761 shows pseudocode for a step, a value associated with performing the step, whether the right shift registers right shift data, and an atomic operation performed by the AFU.

The i-GELU approximation 771 is defined as

$$\frac{1}{2} x [ 1 + L ( \frac{x}{\sqrt{2}} ) ]$$

where L(x)=−sign(x)[(\sqrt{−a}·clip(|x|, max=b)−\sqrt{−a}·b)²−1. where x is an input and a and b are constants. At step 1, RA X stores x. At step 2, RA A stores the value

$$\frac{1}{\sqrt{2}} .$$

At step 3, RA B stores the value x. At step 4, the accumulator of the MAC array is reset. At step 5, the MAC array multiplies the values x and

$$\frac{1}{\sqrt{2}}$$

to generate

$$\frac{x}{\sqrt{2}}$$

The MAC array can provide the value

$$\frac{x}{\sqrt{2}}$$

to the AFU. The AFU can utilize the value

$$\frac{x}{\sqrt{2}}$$

to perform the atomic operation clip(|x|*). The output of the AFU is

$$y = clip ( \frac{x}{\sqrt{2}} ) .$$

At step 6, RA A stores y

$$( e . g . , clip ( \frac{x}{\sqrt{2}} ) ) .$$

At step 7, KA B stores the value \sqrt{−a}. At step 8, the accumulator of the MAC array is reset. At step 9, the values y and \sqrt{−a} are multiplied using the MAC array resulting in the value

$$y = \sqrt{- a} \cdot clip ( \frac{x}{\sqrt{2}} )$$

being stored in the accumulator of the MAC array.

At step 10, RA A stores 1. At step 11, RA B stores the value −\sqrt{−a}·b. At step 12, the values 1 and −\sqrt{−a}·b are multiplied using the MAC array resulting in the value y=−\sqrt{−a}·b being added to the values stored in the accumulator of the MAC array. The value −\sqrt{−a}·b is added to the value

$$\sqrt{- a} \cdot clip ( \frac{x}{\sqrt{2}} )$$

resulting in

$$y = \sqrt{- a} \cdot clip ( \frac{x}{\sqrt{2}} ) - \sqrt{- a} \cdot b$$

being stored in the accumulator of the MAC array.

At step 13, RA A stores y. At step 14, RA B stores the value y. The value y is provided to RA A and RA B from the AFU. The AFU receives the value y from the MAC array. At step 15, the accumulator of the MAC array is reset. At step 16, the MAC array multiplies the values stored in RA A and RA b resulting in

$$y = {( \sqrt{- a} \cdot clip ( \frac{x}{\sqrt{2}} ) - \sqrt{- a} \cdot b )}^{2}$$

being stored in the accumulator of the MAC array.

At step 17, RA A stored the value −1. At step 18, RA B store the value 1. At step 19, the MAC array multiplies the values −1 and 1 resulting in the value −1 and adds the value −1 to the value stored in the accumulator. The MAC array stores

$$y = {( \sqrt{- a} \cdot clip ( \frac{x}{\sqrt{2}} ) - \sqrt{- a} \cdot b )}^{2} - 1$$

in the accumulator.

At step 20, RA A stored the value y. At step 21, RA B store the value x. At step 21, the AFU also performs the operation −sign( ) utilizing the value x such that the output is −sign(x). At step 22, the accumulator of the MAC array is reset. At step 23, the MAC array multiplies y and −sign(x). Given that x has the value of

$$\frac{x}{\sqrt{2}} ,$$

the MAC array multiplies y and

$$- sign ( \frac{x}{\sqrt{2}} ) .$$

The result

$$y = - sign ( \frac{x}{\sqrt{2}} ) [ {( \sqrt{- a} \cdot clip ( \frac{x}{\sqrt{2}} ) - \sqrt{- a} \cdot b )}^{2} - 1 ]$$

is stored in the accumulator.

At step 24, RA A stored the value y. At step 25, RA B stores the value 1. At step 26, the accumulator of the MAC array is reset. At step 27, the MAC array multiplies the values stored in RA A and RA B to generate the output

$$y = [ L ( \frac{X}{\sqrt{2}} ) ] where \\ L ( \frac{X}{\sqrt{2}} ) = - sign ( \frac{X}{\sqrt{2}} ) [ {( \sqrt{- a} \cdot clip ( \frac{x}{\sqrt{2}} ) - \sqrt{- a} \cdot b )}^{2} - 1 ] .$$

At step 28, RA A stored the value 1. At step 29, RA B stores the value 1. At step 30, the MAC array multiplies 1*1 to generate the output 1. The MAC then accumulates 1 and y which is stored int the accumulator to generate the output

$$y = [ 1 + L ( \frac{X}{\sqrt{2}} ) ]$$

At step 31, RA A stores the value y. At step 32, RA B stores the value x. At step 33, the accumulator of the MAC array is reset. At step 34, MAC array multiplies the values stored in RA A and RA B resulting in

$$y = x [ 1 + L ( \frac{X}{\sqrt{2}} ) ] .$$

At step 34, the shift register also right shifts the output of the MAC array resulting in the value

$$y = \frac{1}{2} x [ 1 + L ( \frac{X}{\sqrt{2}} ) ]$$

being provided to the global bus through the AFU. The activation function

$$y = \frac{1}{2} x [ 1 + L ( \frac{X}{\sqrt{2}} ) ]$$

can be utilized to implement an ANN.

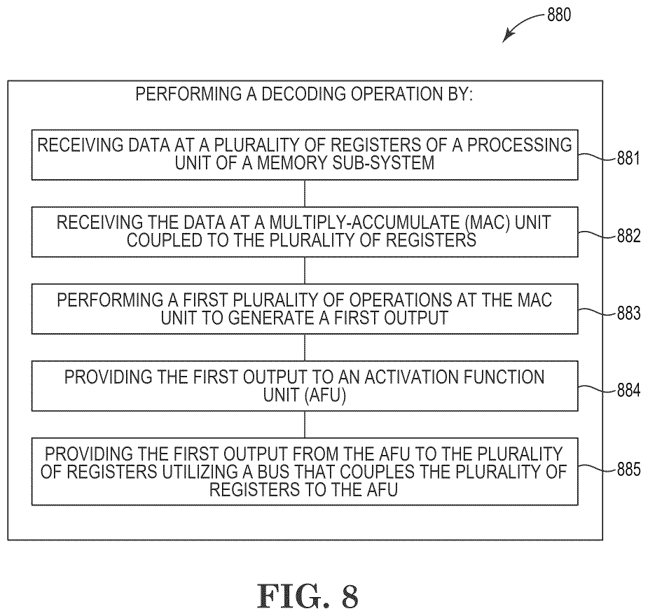

FIG. 8 is a flow diagram corresponding to a method 880 for implementing a processing unit comprising an activation function unit in accordance with some embodiments of the present disclosure. The method 880 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 880 is performed by the PU 112 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 880 includes implementing a PU 412 having an AFU 434. At 881, data can be received at a plurality of registers 431-1, 431-2 of a PU 412 of a memory sub-system 103. The PU 412 can be implemented between banks 221 of the memory sub-system 103. The banks 221 can be organized into bank groups. The plurality of registers 431-1, 431-2 can include a first plurality of registers and a second plurality of registers. At 882, the data can be received at a MAC unit 432 coupled to the plurality of register 431-1, 431-2. The first plurality of registers and the second plurality of registers can be coupled to the MAC unit. The MAC unit 432 can also be referred to as a MAC array.

At 883, a first plurality of operations can be performed at the MAC unit 432 to generate a first output. The first plurality of operations can be performed utilizing a multiplier 437, an adder 438, and registers 439, referred to as an accumulator. At 884, the first output can be provided to an AFU 434. At 885, the first output can be provided from the AFU 434 to the plurality of registers 431-1, 431-2 utilizing a bus 442 that couples the plurality of registers 431-1, 431-2 to the AFU 434. In other examples, the first output can be provided from the AFU to the plurality of registers utilizing a line or a plurality of lines that couple the plurality of registers to the AFU.

The AFU can provide the first output without performing additional operations utilizing the first output. The AFU can provide the first output responsive to receiving a command. The command can be received from the PU control circuitry 108. In various examples, the PU, the registers, the MAC unit, and/or the AFU, among other components of the PU, are described as performing actions. The actions performed by the PU or its components can be coordinated by the PU control circuitry 108. For example, The PU control circuitry 108 can provide a command (e.g., signal) to the AFU to cause the AFU to provide the first output without performing additional operation utilizing the first output.

The AFU can provide the first output to an output bus utilizing a tri-state buffer. The tri-state buffer can allow the AFU to control the output bus or the bus that coupled the AFU to the plurality of registers. The PU control circuitry 108 can control whether the AFU provides data to the output bus of a memory device or provides data to the bus that couples the AFU to the plurality of registers.

The MAC unit can perform a second plurality of operations at the MAC unit to generate a second output. The MAC unit can perform the second plurality of operation utilizing the first output received from the plurality of registers. The MAC unit and the AFU can perform a plurality of operations without providing outputs to the global bus. The AFU can perform a third plurality of operations utilizing the second output. The various instances the AFU can pass the output of the MAC unit without performing additional operations. The AFU can also perform operation on the output of the MAC unit prior to providing its output to the global bus or to the plurality of registers. For example, the second output can be provided to the output bus.

In various examples, a memory device can include an array of memory cells and a PU coupled to the array of memory cells. The PU can include a plurality of registers configured to store data provided by the array. The plurality of registers can also store data provided by an AFU. The PU can include a MAC unit coupled to the plurality of registers. The MAC unit can perform a first plurality of operations on the data. The PU can also include an AFU that can be coupled to the MAC unit. The AFU can perform a second plurality of operations on an output of the MAC unit. The PU can include a first plurality of lines that couple the AFU to the plurality of registers. The plurality of lines can provide an output of the AFU unit to the plurality of registers to perform a polynomial operation.

The MAC unit can provide the output to the AFU unit via a multiplexor. The multiplexor can allow data to flow from the MAC unit to the AFU or data to flow from a different plurality of registers. The PU can also include a MUX. The MUX can provide the output of the AFU to the MAC unit via the plurality of registers.

In various instances, the AFU can provide its own output to a de-MUX. The de-MUX can be part of the PU. The de-MUX can provide the output of the AFU to a global bus or to the plurality of lines.

The PU can also include a MUX that receives the output of the AFU unit and the data. The MUX can provide the output of the AFU unit or the data to the plurality of registers. The plurality of registers can store the output of the AFU unit responsive to receipt of the output of the AFU unit from the MUX. The second plurality of operations performed by the AFU can be atomic operations The atomic operations may not be supported by the MAC unit.

In various examples, the PU can comprise a first plurality of registers, a MAC unit, an AFU, and a plurality of lines. The first plurality of registers can store data provided by the array. The MAC unit can be coupled to the first plurality of registers and can perform a first plurality of operations on the data. The data can be received from the first plurality of registers. The PU can include an AFU coupled to the MAC unit and can perform a second plurality of operations utilizing a first output provided by the MAC unit. The MAC unit can provide its own output to the AFU. The PU can include a first plurality of lines. The first plurality of lines can provide the second output of the AFU as an input to the AFU. The first plurality of lines can couple the output of the AFU to the input of the AFU. The AFU can perform a second plurality of operations utilizing the input, wherein the input the second output of the AFU.

The first plurality of signal lines can couple the AFU to a second plurality of registers. The second plurality of registers can provide the second output to the AFU via a second plurality of lines that couple the second plurality of registers to the AFU. The second plurality of lines and the second plurality of registers allow the AFU to perform operations on its own outputs. For example, the AFU can perform a third plurality of operations utilizing the second output. The PU can also include a third plurality of lines to provide a third output of the AFU to the first plurality of registers to perform a polynomial operation.

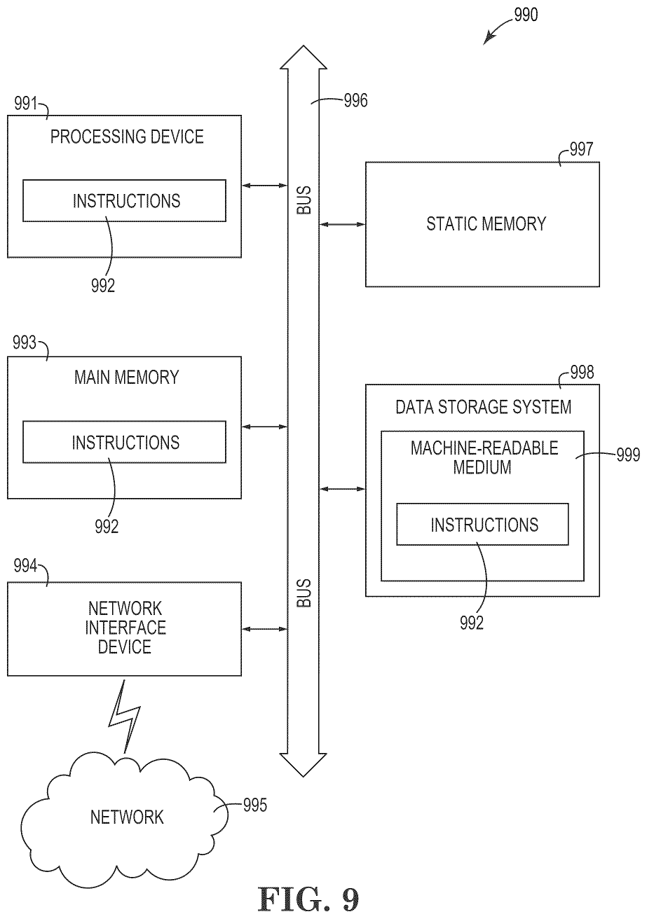

FIG. 9 is a block diagram of an example computer system in which embodiments of the present disclosure may operate. For example, FIG. 9 illustrates an example machine of a computer system 990 within which a set of instructions, for causing the machine to perform any one or more of the methodologies discussed herein, can be executed. In some embodiments, the computer system 990 can correspond to a host system (e.g., the host system 102 of FIG. 1) that includes, is coupled to, or utilizes a memory sub-system (e.g., the memory sub-system 103 of FIG. 1) or can be used to perform the operations of a controller (e.g., to execute an operating system to perform operations corresponding to the PU 112 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 990 includes a processing device 991, a main memory 993 (e.g., read-only memory (ROM), flash memory, dynamic random access memory (DRAM) such as synchronous DRAM (SDRAM) or Rambus DRAM (RDRAM), etc.), a static memory 997 (e.g., flash memory, static random access memory (SRAM), etc.), and a data storage system 998, which communicate with each other via a bus 996.

The processing device 991 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 991 can also be one or more special-purpose processing devices such as an application specific integrated circuit (ASIC), a field programmable gate array (FPGA), a digital signal processor (DSP), network processor, or the like. The processing device 991 is configured to execute instructions 992 for performing the operations and steps discussed herein. The computer system 990 can further include a network interface device 994 to communicate over the network 995.

The data storage system 998 can include a machine-readable storage medium 999 (also known as a computer-readable medium) on which is stored one or more sets of instructions 992 or software embodying any one or more of the methodologies or functions described herein. The instructions 992 can also reside, completely or at least partially, within the main memory 993 and/or within the processing device 991 during execution thereof by the computer system 990, the main memory 993 and the processing device 991 also constituting machine-readable storage media. The machine-readable storage medium 999, data storage system 998, and/or main memory 993 can correspond to the memory sub-system 103 of FIG. 1.

In one embodiment, the instructions 992 include instructions to implement functionality corresponding to the processing unit (e.g., the PU 112 of FIG. 1). While the machine-readable storage medium 999 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
an array of memory cells;
a processing unit coupled to the array of memory cells, comprising:
a plurality of registers configured to store data provided by the array;
a multiply-accumulate (MAC) unit coupled to the plurality of registers and configured to perform a first plurality of operations on the data;
an activation function unit (AFU) coupled to the MAC unit and configured to perform a second plurality of operations on an output of the MAC unit;
a plurality of signal lines that couple the AFU to the plurality of registers and which is configured to provide an output of the AFU unit to the plurality of registers to perform a polynomial operation.

2. The apparatus of claim 1, wherein the MAC unit is further configured to provide the output to the AFU unit via a multiplexor (MUX).

3. The apparatus of claim 1, wherein the processing unit further comprises a MUX configured to provide the output of the AFU to the MAC unit via the plurality of registers.

4. The apparatus of claim 1, wherein the AFU is further configured to provide the output of the AFU unit to a de-MUX.

5. The apparatus of claim 4, wherein the processing unit further comprises the de-MUX configured to provide the output of the AFU to a global bus or to the plurality of signal lines.

6. The apparatus of claim 1, wherein the processing unit further comprises a MUX configured to receive the output of the AFU unit and the data.

7. The apparatus of claim 6, wherein the MUX is further configured to provide the output of the AFU unit or the data to the plurality of registers.

8. The apparatus of claim 7, wherein the plurality of registers are configured to store the output of the AFU unit responsive to receipt of the output of the AFU unit from the MUX.

9. The apparatus of claim 1, wherein the second plurality of operations are atomic operations not supported by the MAC unit.

10. A method, comprising:
receiving data at a plurality of registers of a processing unit of a memory sub-system;
receiving the data at a multiply-accumulate (MAC) unit coupled to the plurality of registers;
performing a first plurality of operations at the MAC unit to generate a first output;
providing the first output to an activation function unit (AFU); and
providing the first output from the AFU to the plurality of registers utilizing a bus that couples the plurality of registers to the AFU.

11. The method of claim 10, wherein the AFU provides the first output without performing additional operations utilizing the first output.

12. The method of claim 11, wherein the AFU provides the first output responsive to receiving a command.

13. The method of claim 11, wherein the AFU provides the first output to an output bus utilizing a tri-state buffer.

14. The method of claim 13, further comprising, providing the first output to the plurality of registers utilizing the tri-state buffer.

15. The method of claim 10, further comprising:
performing a second plurality of operations at the MAC unit to generate a second output utilizing the first output received from the plurality of registers;
performing a third plurality of operations at the AFU utilizing the second output; and
providing the second output to an output bus.

16. An apparatus, comprising:
an array of memory cells;
a processing unit coupled to the array of memory cells, comprising:
a first plurality of registers configured to store data provided by the array;
a multiply-accumulate (MAC) unit coupled to the first plurality of registers and configured to perform a first plurality of operations on the data;
an activation function unit (AFU) coupled to the MAC unit and configured to perform a second plurality of operations utilizing a first output provided by the MAC unit;
a first plurality of signal lines configured to provide a second output of the AFU as an input to the AFU;
wherein the AFU is further configured to perform a second plurality of operations utilizing the input.

17. The apparatus of claim 16, wherein the first plurality of signal lines is coupled to a second plurality of registers.

18. The apparatus of claim 17, wherein the second plurality of registers are configured to provide the second output to the AFU via a second plurality of signal lines that couple the second plurality of registers to the AFU.

19. The apparatus of claim 18, wherein the AFU is further configured to perform a third plurality of operations utilizing the second output.

20. The apparatus of claim 19, wherein the processing unit further comprises a third plurality of signal lines configured to provide a third output of the AFU to the first plurality of registers to perform a polynomial operation.
